(19) United States
(12) Patent Application Publication
(10) Pub. No.: US 2026/0253778 A1
(43) Pub. Date: Aug. 27, 2026

(54) INTEGRATED COMMON-MODE INDUCTOR AND SWITCHING POWER CONVERTER HAVING THE SAME

(71) Applicant: ASIAN POWER DEVICES INC., Taoyuan City (TW)

(72) Inventor: Tsung-Liang HUNG, Taoyuan City (TW)

(73) Assignee: ASIAN POWER DEVICES INC., Taoyuan City (TW)

(21) Appl. No.: 19/183,243

(22) Filed: Apr. 18, 2025

(30) Foreign Application Priority Data
Feb. 21, 2025 (TW) 114106454

(51) Int. Cl. H01F 27/00; H01F 27/24; H01F 27/42; H01F 38/14; H02M 1/088; H02M 1/34; H02M 1/44; H02M 7/00

(52) U.S. Cl. CPC H01F 27/006; H01F 27/24; H01F 27/427; H01F 38/14; H02M 1/088; H02M 1/344; H02M 1/44; H02M 7/003

(57) ABSTRACT

An integrated common-mode inductor includes an iron core, a first winding, a second winding, and a third winding. The iron core includes a center magnetic part, a first side magnetic part, and a second side magnetic part. The first winding is wound on the second side magnetic part, and wound on the first side magnetic part. The second winding is wound on the second side magnetic part. The third winding is wound on the second side magnetic part. The first winding wound on the first side magnetic part provides a differential-mode magnetic flux. The first winding, the second winding, and the third winding wound on the second side magnetic part provide a common-mode magnetic flux.

### CROSS-REFERENCE TO RELATED APPLICATION

This application claims benefit of priority to Taiwanese Patent Application No. 114106454 filed Feb. 21, 2025, the entire contents of which are incorporated herein by reference.

### BACKGROUND

### Technical Field

The present disclosure relates to an integrated common-mode inductor, and particularly to an integrated common-mode inductor with common-node and differential-mode noise cancellation.

### Description of Related Art

The statements in this section merely provide background information related to the present disclosure and do not necessarily constitute prior art.

In the structure of the related-art switching power converter, there is typically a common-mode noise filter at its input terminal, consisting of a common-mode inductor and Y capacitors (including a capacitor C₁ and a capacitor C₂). This common-mode noise filter usually has one to three sets. Due to the frequency range of conduction electromagnetic interference (EMI) ranging from 150 kHz to 30 MHz, and the fact that filters typically have limited response bandwidth, multiple sets of filters are required.

The performance of a filter is directly related to the attenuation performance within the bandwidth. In order to achieve better noise attenuation, traditional methods use common-mode inductors with two windings N₁, N₂, which require higher inductance, and therefore they have larger size and higher cost. Moreover, a high-inductance inductor typically requires a greater number of wire windings, resulting in increased efficiency losses and heat generation. Please refer to FIG. 1, which shows a circuit diagram of a first embodiment of a conventional switching power converter. From FIG. 1, it is evident that the common-mode current i_{cm} typically flows through the secondary side and is transmitted to the ground FG, and then returns to a line impedance stabilization network (LISN) via the ground FG. Subsequently, the common-mode current i_{cm} is detected by the EMI receiver.

Furthermore, please refer to FIG. 2 and FIG. 3, which show a circuit diagram of a second embodiment and a third embodiment of the conventional switching power converter respectively. Compared to FIG. 1, although an inductor having three windings (N₁, N₂, N₃) is used as the common-mode noise cancellation filters 93A, 93B, and it is very effective in cancelling common-mode noise, it has no effect on the differential-mode noise. Therefore, in the circuits of FIG. 2 and FIG. 3, it is still necessary to use a physical independent differential-mode filter inductor 92, which will obstruct the development of miniaturization of electronic products.

Specifically, please refer to FIG. 4, which shows a schematic diagram of an inductor core structure in a separated form of FIG. 2 and FIG. 3. In this structure, it can be seen that the inductor core of the differential-mode filter inductor 92 and the inductor core of the common-mode noise cancellation filters 93A, 93B are separated and have independent windings wound thereon. The inductor core of the differential-mode filter inductor 92 is the winding N_{X}, and the inductor cores of the common-mode noise cancellation filters 93A, 93B are the windings N₁, N₂, N₃. Therefore, as mentioned above, this structure of the separated inductor core will not be easy to reduce the size of the inductor, and is therefore not conducive to the development of miniaturization of electronic products.

Therefore, how to design an integrated common-mode inductor to solve the problems and technical bottlenecks in the existing technology has become a critical topic in this field.

### SUMMARY

An objective of the present disclosure is to provide an integrated common-mode inductor. The integrated common-mode inductor includes an iron core, a first winding, a second winding, and a third winding. The iron core includes a center magnetic part, a first side magnetic part, and a second side magnetic part. The first winding includes a first terminal and a second terminal. The first winding is wound on the second side magnetic part, and wound on the first side magnetic part to form a structure where the first terminal of the first winding and the second terminal of the first winding are wound out from the first side magnetic part and the second side magnetic part respectively. The second winding includes a first terminal and a second terminal. The second winding is wound on the second side magnetic part to form a structure where the first terminal of the second winding and the second terminal of the second winding are wound out from two sides of the second side magnetic part respectively. The third winding includes a first terminal and a second terminal. The third winding is wound on the second side magnetic part to form a structure where the first terminal of the third winding and the second terminal of the third winding are wound out from the two sides of the second side magnetic part respectively. The first winding wound on the first side magnetic part provides a differential-mode magnetic flux. The first winding, the second winding, and the third winding wound on the second side magnetic part provide a common-mode magnetic flux.

In one embodiment, the first winding is wound on the second side magnetic part, and directly extends to be wound on the first side magnetic part.

In one embodiment, the first winding is wound on the second side magnetic part, and is wound on the first side magnetic part through a circuit board.

In one embodiment, the first side magnetic part and the center magnetic part provide a differential-mode closed magnetic loop through which the differential-mode magnetic flux passes. The second side magnetic part and the center magnetic part provide a common-mode closed magnetic loop through which the common-mode magnetic flux passes.

In one embodiment, a direction of the differential-mode closed magnetic loop at the center magnetic part is the same as a direction of the common-mode closed magnetic loop at the center magnetic part.

In one embodiment, at a time-varying moment, the differential-mode closed magnetic loop is formed by the first side magnetic part and the center magnetic part in a clockwise direction; the common-mode closed magnetic loop is formed by the second side magnetic part and the center magnetic part in a counter clockwise direction.

In one embodiment, at a time-varying moment, the differential-mode closed magnetic loop is formed by the first side magnetic part and the center magnetic part in a counter clockwise direction; the common-mode closed magnetic loop is formed by the second side magnetic part and the center magnetic part in a clockwise direction.

In one embodiment, a polarity of the first winding that wound out from one side of the second side magnetic part is the same as a polarity of the second winding and a polarity of the third winding that wound out from the same side of the second side magnetic part.

Another objective of the present disclosure is to provide a switching power converter. The switching power converter includes a transformer, a primary-side circuit, and a voltage conversion circuit. The transformer includes a primary side and a secondary side. The primary-side circuit is coupled to the primary side, and the primary-side circuit includes a line impedance stabilization network and a noise cancellation circuit. The line impedance stabilization network receives an input power source. The noise cancellation circuit includes a first capacitor, an integrated common-mode inductor, and a second capacitor. The integrated common-mode inductor is coupled to the first capacitor, and the integrated common-mode inductor includes an iron core, a first winding, a second winding, and a third winding. The second capacitor is coupled to the integrated common-mode inductor. The voltage conversion circuit is coupled between the integrated common-mode inductor and the primary side.

In one embodiment, the first capacitor is coupled between an output side of the line impedance stabilization network and an input side of the integrated common-mode inductor.

In one embodiment, the first capacitor is coupled between the second terminal of the first winding and the second terminal of the second winding and the second terminal of the third winding.

In one embodiment, the first capacitor is coupled between an extension section of the first winding and the second terminal of the second winding and the second terminal of the third winding.

In one embodiment, the second terminal of the second winding is coupled to the second terminal of the third winding, a first terminal of the second capacitor is coupled to the first terminal of the third winding, and a second terminal of the second capacitor is grounded.

In one embodiment, the first terminal of the second winding is coupled to the first terminal of the third winding, a first terminal of the second capacitor is coupled to the second terminal of the third winding, and a second terminal of the second capacitor is grounded.

In one embodiment, the third winding generates a reverse current equivalent to a magnitude of a common-mode noise current.

In one embodiment, the noise cancellation circuit has a function of a current transformer.

In one embodiment, the noise cancellation circuit further has a function of a signal amplifier and/or a function of a signal inverter.

In one embodiment, the primary-side circuit further a protection circuit. The protection circuit is coupled to the primary side of the transformer.

Therefore, the integrated common-mode inductor proposed by the present disclosure can achieve the following features and advantages: 1. Without adding independent magnetic components, the shared core magnetic circuit can be used as an integrated inductor, which conducive to the miniaturization of components; 2. It is to achieve reduction in EMI interference emission intensity of common-mode and differential-mode noise currents; 3. A structure of the common-mode noise cancellation circuit composed entirely of passive components, as evident from experimental results, clearly shows that the same components, when using common-mode noise cancellation techniques, can achieve better common-mode noise cancellation performance; 4. Compared to the traditional passive LC filters under the same number of components, the present disclosure only requires the addition of the third winding. However, since the third winding carries a smaller current, it can be made using finer enameled wire without significantly increasing the size and cost of the coupled inductor; 5. Using a small-size common-mode choke (CM choke) achieves higher filtering performance, and the reduced number of windings and compact size of the CM choke contribute to efficient and compact design; 6. Addition of the third winding using parallel winding method with the existing windings, and the third winding has a smaller wire diameter (lower current), which does not significantly increase the cost; 7. Reliability is higher in designs that are fully composed of passive components.

It is to be understood that both the foregoing general description and the following detailed description are exemplary, and are intended to provide further explanation of the present disclosure as claimed. Other advantages and features of the present disclosure will be apparent from the following description, drawings, and claims.

### BRIEF DESCRIPTION OF DRAWINGS

The present disclosure can be more fully understood by reading the following detailed description of the embodiment, with reference made to the accompanying drawing as follows:

FIG. 1 is a circuit diagram of a first embodiment of a conventional switching power converter.

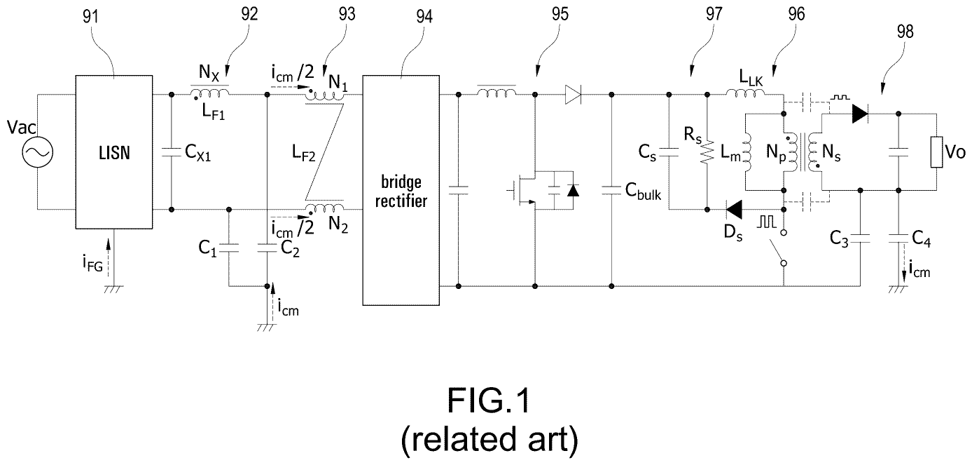

FIG. 2 is a circuit diagram of a second embodiment of the conventional switching power converter.

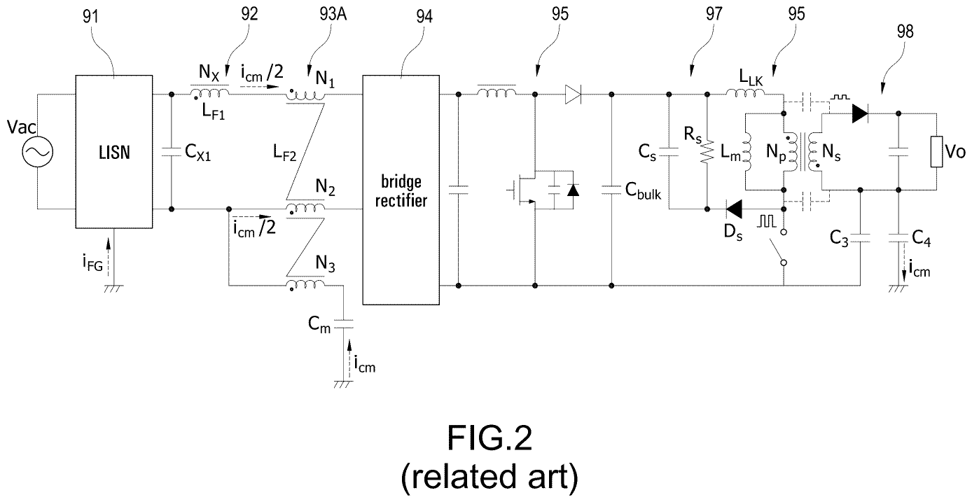

FIG. 3 is a circuit diagram of a third embodiment of the conventional switching power converter.

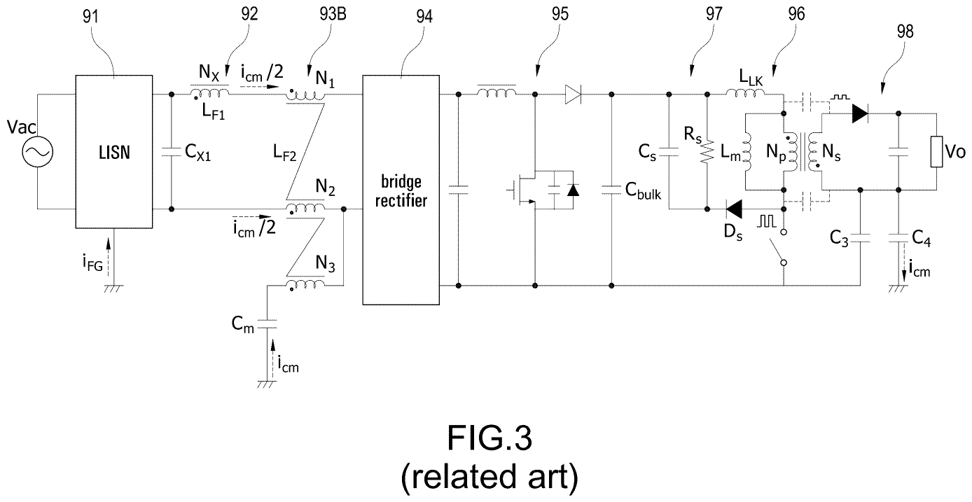

FIG. 4 is a schematic diagram of an inductor core structure in a separated form of FIG. 2 and FIG. 3.

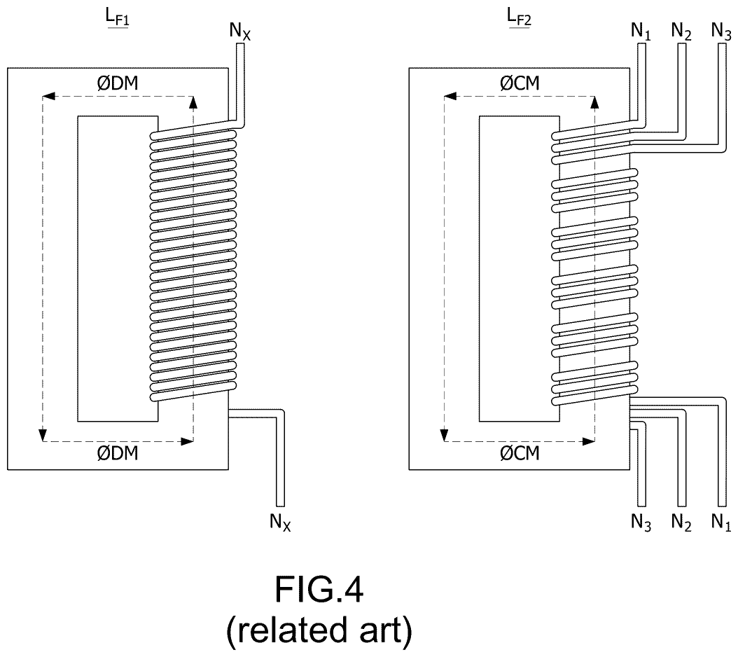

FIG. 5A is a schematic diagram of an integrated common-mode inductor according to a first embodiment of the present disclosure.

FIG. 5B is a schematic diagram of the integrated common-mode inductor according to a second embodiment of the present disclosure.

FIG. 6A is a circuit diagram of a switching power converter using the integrated common-mode inductor according to a first embodiment of the present disclosure.

FIG. 6B is a circuit diagram of the switching power converter using the integrated common-mode inductor according to a second embodiment of the present disclosure.

FIG. 7A is a circuit diagram of the switching power converter using the integrated common-mode inductor according to a third embodiment of the present disclosure.

FIG. 7B is a circuit diagram of the switching power converter using the integrated common-mode inductor according to a fourth embodiment of the present disclosure.

### DETAILED DESCRIPTION

Reference will now be made to the drawing figures to describe the present disclosure in detail. It will be understood that the drawing figures and exemplified embodiments of present disclosure are not limited to the details thereof.

The implementation of the present disclosure is described below through specific examples, and those who are familiar with this technology can easily understand other advantages and effects of the present disclosure from the content disclosed in this specification. The present disclosure can also be implemented or applied through other different specific examples, and the details in the present disclosure can also be modified and changed based on different viewpoints and applications without departing from the spirit of the present disclosure.

The structures, proportions, sizes, and number of components shown in the drawings attached to the present disclosure are only used to match the content in the present disclosure, for those who are familiar with this technology to understand and read, and are not used to limit the implementation of the present disclosure. Any modification of structure, change of proportional relationship or adjustment of size shall fall within the scope covered by the technical content disclosed in the present disclosure, provided that it does not affect the effect and purpose of the present disclosure.

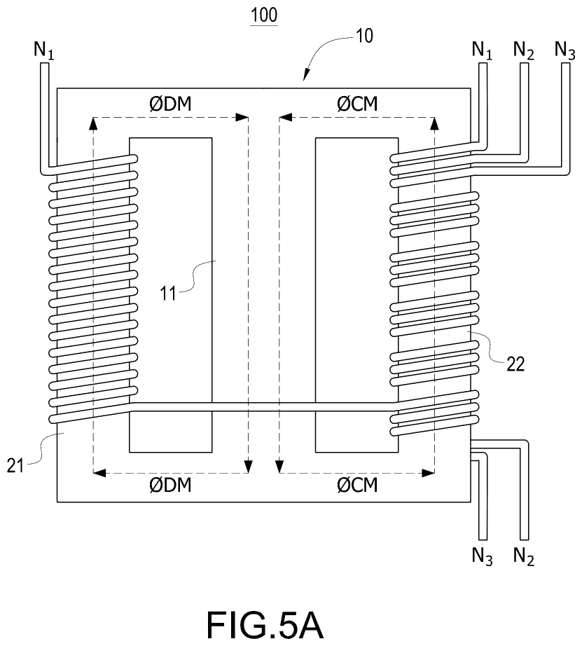

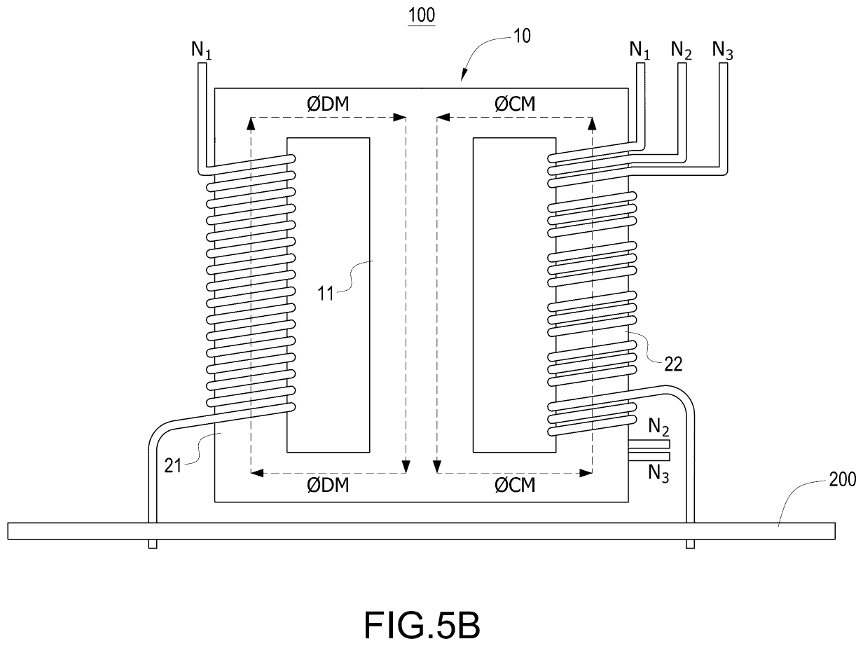

Please refer to FIG. 5A, which shows a schematic diagram of an integrated common-mode inductor according to a first embodiment of the present disclosure. The integrated common-mode inductor 100 includes an iron core 10, a first winding N₁, a second winding N₂, and a third winding N₃. The iron core 10 incudes a center magnetic part 11, a first side magnetic part 21, and a second side magnetic part 22. Incidentally, the center magnetic part 11 may also be referred to as a center column, and the first side magnetic part 21 and the second side magnetic part 22 may also be referred to as a first side column and a second side column. The material of the iron core 10 may be ceramic magnetic material or metallic soft magnetic material. For ceramic magnetic materials, they are mainly nickel-zinc ferrite, manganese-zinc ferrite, magnesium-copper-zinc ferrite and other materials. For metallic soft magnetic materials, they mainly include iron alloy magnetic powders such as carbon-based iron powder, iron-nickel, iron-silicon, iron-silicon-aluminum, iron-silicon-chromium, and amorphous alloys.

Furthermore, the iron core 10 of the present disclosure may be a box-like structure to provide the center magnetic part 11, the first side magnetic part 21, and the second side magnetic part 22. Specifically, the box-like iron core 10 may be an integrally formed structure, or a two-piece structure, such as consisting of an E-shaped iron core and an I-shaped iron core, or consisting of a C-shaped iron core and a T-shaped iron core, or consisting of two E-shaped iron cores, but this is not intended to limit the present disclosure.

The first winding N₁ has a first terminal and a second terminal. The first winding N₁ is wound on the second side magnetic part 22, and directly extends to be wound on the first side magnetic part 21 to form a structure where the first terminal of the first winding and the second terminal of the first winding are wound out from the first side magnetic part and the second side magnetic part respectively. As sown in FIG. 5A, for example, the first terminal of the first winding N₁ is the outlet terminal at the upper right side of FIG. 5A, and the second terminal of the first winding N₁ is the outlet terminal at the upper left side of FIG. 5A. Alternatively, the first terminal of the first winding N₁ is the outlet terminal at the upper left side of FIG. 5A, and the second terminal of the first winding N₁ is the outlet terminal at the upper right side of FIG. 5A.

The second winding N₂ has a first terminal and a second terminal. The second winding N₂ is wound on the second side magnetic part 22 to form a structure where the first terminal of the second winding and the second terminal of the second winding are wound out from two sides of the second side magnetic part respectively. As sown in FIG. 5A, for example, the first terminal of the second winding N₂ is the outlet terminal at the upper right side of FIG. 5A, and the second terminal of the second winding N₂ is the outlet terminal at the lower right side of FIG. 5A. Alternatively, the first terminal of the second winding N₂ is the outlet terminal at the lower right side of FIG. 5A, and the second terminal of the second winding N₂ is the outlet terminal at the upper right side of FIG. 5A.

The third winding N₃ has a first terminal and a second terminal. The third winding N₃ is wound on the second side magnetic part 22 to form a structure where the first terminal of the third winding and the second terminal of the third winding are wound out from the two sides of the second side magnetic part respectively. As sown in FIG. 5A, for example, the first terminal of the third winding N₃ is the outlet terminal at the upper right side of FIG. 5A, and the second terminal of the third winding N₃ is the outlet terminal at the lower right side of FIG. 5A. Alternatively, the first terminal of the third winding N₃ is the outlet terminal at the lower right side of FIG. 5A, and the second terminal of the third winding N₃ is the outlet terminal at the upper right side of FIG. 5A.

The first winding N₁ wound on the first side magnetic part 21 provides a differential-mode magnetic flux ΦDM. The first winding N₁, the second winding N₂, and the third winding N₃ wound on the second side magnetic part 22 provide a common-mode magnetic flux ΦCM.

Specifically, the first side magnetic part 21 and the center magnetic part 11 provide a differential-mode closed magnetic loop through which the differential-mode magnetic flux ΦDM passes. As shown in FIG. 5A, at a time-varying moment, the differential-mode closed magnetic loop through which the differential-mode magnetic flux ΦDM passes is formed by the first side magnetic part 21 and the center magnetic part 11 in a clockwise direction. The common-mode closed magnetic loop is formed by the second side magnetic part 22 and the center magnetic part 11 in a counter clockwise direction. As shown in FIG. 5A, at a time-varying moment, the common-mode closed magnetic loop through which the common-mode magnetic flux ΦCM passes is formed by the second side magnetic part 22 and the center magnetic part 11 in a counter clockwise direction. Therefore, a direction of the differential-mode closed magnetic loop at the center magnetic part 11 is the same as a direction of the common-mode closed magnetic loop at the center magnetic part 11. For example, the direction of the differential-mode closed magnetic loop at the center magnetic part 11 is a downward direction from the FIG. 5A, and the direction of the common-mode closed magnetic loop at the center magnetic part 11 is the downward direction from the FIG. 5A. Therefore, the direction of the differential-mode closed magnetic loop at the center magnetic part 11 is the same as the direction of the common-mode closed magnetic loop at the center magnetic part 11.

However, this does not limit the present disclosure, that is, at a time-varying moment, the differential-mode closed magnetic loop through which the differential-mode magnetic flux ΦDM passes is formed by the first side magnetic part 21 and the center magnetic part 11 in a counter clockwise direction. The common-mode closed magnetic loop is formed by the second side magnetic part 22 and the center magnetic part 11 in a clockwise direction. Therefore, a direction of the differential-mode closed magnetic loop at the center magnetic part 11 is the same as a direction of the common-mode closed magnetic loop at the center magnetic part 11, that is, the direction of the differential-mode closed magnetic loop at the center magnetic part 11 is the upward direction from the FIG. 5A, and the direction of the common-mode closed magnetic loop at the center magnetic part 11 is the upward direction from the FIG. 5A.

Therefore, by extending the first winding N₁ from one side column of the iron core 10 (for example, the second side magnetic part 22) and winding it to the other side column of the iron core 10 (for example, the first side magnetic part 21) so that in addition to the existing common-mode closed magnetic loop of common-mode magnetic flux ΦCM, and the extended first winding N₁ further realizes a differential-mode closed magnetic loop of the differential-mode magnetic flux ΦDM. Therefore, it can be seen from FIG. 5A that without adding independent magnetic components, the shared core magnetic circuit can be used as an integrated inductor, which conducive to the miniaturization of components.

Please refer to FIG. 5B, which shows a schematic diagram of the integrated common-mode inductor according to a second embodiment of the present disclosure. Compared to the first embodiment shown in FIG. 5A, the first winding N₁ is wound on the second side magnetic part 22, and is wound on the first side magnetic part 21 through a circuit board 200. In other words, the first winding N₁ wound on the second side magnetic part 22 is not directly extended and wound on the first side magnetic part 21 as shown in FIG. 5A, but indirectly through the circuit board 200. Therefore, by utilizing the electrical connection on the circuit board 200, the first winding N₁ wound on the second side magnetic part 22 is wound on the first side magnetic part 21 through the circuit board 200. Therefore, the technical characteristics and functions of the above-mentioned FIG. 5A can also be achieved. Incidentally, although FIG. 5A and FIG. 5B disclose the means by which the first winding N₁ is wound on the second side magnetic part 22 and the first side magnetic part 21, the present disclosure is not limited thereto. Any method that can realize winding the first winding N₁ on the second side magnetic part 22 and the first side magnetic part 21 should be included in the scope of the present disclosure.

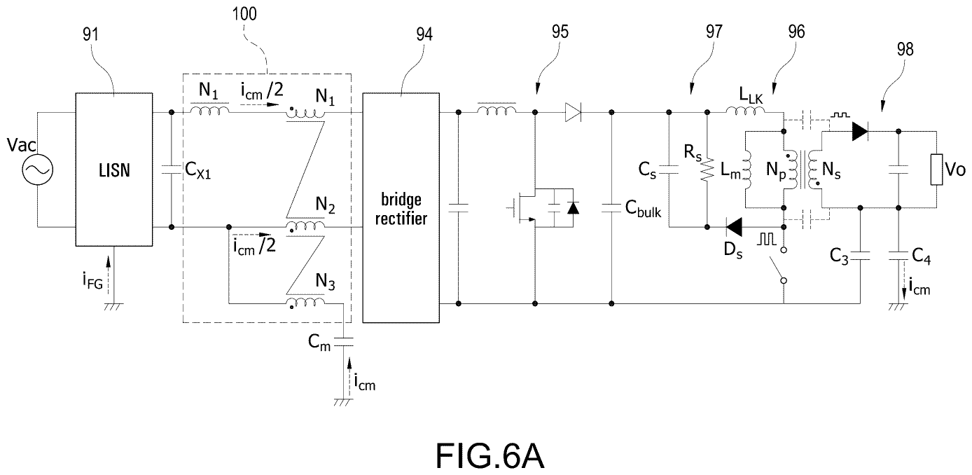

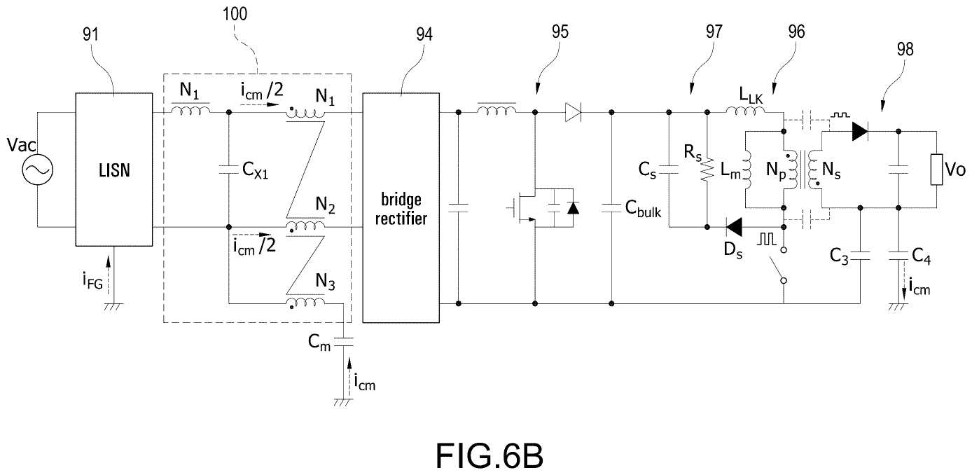

Please refer to FIG. 6A, which shows a circuit diagram of a switching power converter using the integrated common-mode inductor according to a first embodiment of the present disclosure. As shown in FIG. 6A, the switching power converter includes a transformer 96, a primary-circuit circuit, and a secondary-side circuit. The transformer 96 has a primary side and a secondary side. The primary-side circuit is coupled to the primary side, and the secondary-side circuit is coupled to the secondary side.

The primary-side circuit includes a line impedance stabilization network (LISN) 91, a first capacitor C_{X1}, an integrated common-mode inductor 100, a second capacitor Cₘ, a bridge rectifier 94, and a voltage conversion circuit 95. Furthermore, the primary-side circuit further includes a protection circuit 97. In particular, the bridge rectifier 94 is used to convert an AC power source into a DC power source, and therefore when the input power source is an AC power source, the bridge rectifier 94 needs to be used; otherwise, when the input power source is a DC power source, the bridge rectifier 94 may be omitted. In particular, the first capacitor C_{X1}, the integrated common-mode inductor 100, and the second capacitor Cₘ constitute a noise cancellation circuit.

Hereinafter, the input power source is an AC power source Vac as an example for illustration, but this does not limit the present disclosure, which means that the input power source may also be a DC power source. The line impedance stabilization network (LISN) 91 receives the AC power source Vac. In particular, all electronic devices have to undergo EMI conduction testing before they can be sold. In EMI conduction testing, the output noise from the telecommunication port will interfere with call quality and network transmission rate. Therefore, most telecommunication devices require ISN testing to evaluate the interference on the telecommunication port, in addition to conducting tests on the power supply section. In testing, LISN and ISN are commonly used. The power side testing is usually referred to as LISN testing, and the output port testing is usually referred to as ISN testing. In particular, LISN 91 is used in EMI conduction testing to isolate the power source from the device under test and couple the interference signals from the device under test to the EMC analyzer.

In the embodiment of FIG. 6A, the first capacitor C_{X1} is disposed between the output side of the LISN 91 and the input side of the integrated common-mode inductor 100. Specifically, the first capacitor C_{X1} is disposed between the second terminal of the first winding N₁ and the second terminal of the second winding N₂ and the second terminal of the third winding N₃.

The integrated common-mode inductor 100 is a three-coupled-winding inductor, that is, the inductor includes three windings involving a first winding N₁, a second winding N₂, and a third winding N₃. The notation N₁, N₂, N₃ may also represent the turns ratio of the three windings, that is, the turns ratio between the first winding N₁, the second winding N₂, and the third winding N₃ is N₁:N₂:N₃. As shown in FIG. 5, the second terminal of the first winding N₁ extending from the first side magnetic part 21 is connected to the LISN 91, and the second terminal of the second winding N₂ and the second terminal of the third winding N₃ extending from the second side magnetic part 22 are connected to the LISN 91. Furthermore, the first terminal of the first winding N₁ extending from the second side magnetic part 22 is connected to the bridge rectifier 94, and the first terminal of the second winding N₂ and the first terminal of the third winding N₃ extending from the second side magnetic part 22 are connected to the bridge rectifier 94.

In this embodiment, the second terminal (i.e., the input terminal) of the third winding N₃ is coupled to the second terminal (i.e., the input terminal) of the second winding N₂, and the first terminal (i.e., the output terminal) of the third winding N₃ is coupled to the second capacitor Cₘ. Specifically, the output terminal of the third winding N₃ is coupled to the first terminal of the second capacitor Cₘ, and the second terminal of the second capacitor Cₘ is grounded.

Furthermore, in one embodiment, a polarity of the first winding N₁ that wound out from one side of the second side magnetic part 22 is the same as a polarity of the second winding N₂ and a polarity of the third winding N₃ that wound out from the same side of the second side magnetic part 22, that is, a polarity of the first terminal of the first winding N₁ is the same as a polarity of the first terminal of the second winding N₂ and a polarity of the first terminal of the third winding N₃.

Two input terminals of the bridge rectifier 94 are respectively coupled to the output terminal of the first winding N₁ and the output terminal of the second winding N₂. In this embodiment, the bridge rectifier 94 is an active bridge rectifier (composed of active switch arms) or a passive bridge rectifier (composed of diode arms).

The voltage conversion circuit 95 is coupled between the bridge rectifier 94 and the primary side of the transformer 96. In this embodiment, the voltage conversion circuit 95 may be a boost circuit, a buck circuit, or a buck-boost circuit. As mentioned above, if the bridge rectifier 94 is not required, the voltage conversion circuit 95 is coupled between the output terminal of the first winding N₁, the output terminal of the second winding N₂, and the primary side.

The protection circuit 97 is coupled to the primary side of the transformer 96. In this embodiment, the protection circuit 97 is a clamping circuit, such as an RCD clamping circuit, or the protection circuit 16 is a snubber circuit, such as an RCD snubber. However, the protection circuit 97 of the present disclosure is not limited to the previous disclosed embodiments, and any circuit capable of protecting the primary side of transformer 96 may be used as the protection circuit 97 in the present disclosure. The secondary-side circuit includes an output rectifier 98, and the output rectifier 98 is coupled to a load.

Therefore, the feature of the present disclosure is to use the three-coupled-winding inductor having three windings N₁, N₂, N₃, and the third winding N₃ provides a reverse common-mode noise current i_{cm}. In particular, a current path of the newly added reverse common-mode noise current i_{cm} can replace the total current of the first winding N₁ and the second winding N₂, i.e., i_{cm}/2+i_{cm}/2. Due to the shorter path and lower impedance of the newly added reverse common-mode noise current i_{cm} through the third winding N₃, and the longer path and higher impedance of the ground path FG of the LISN 91, the reverse common-mode noise current i_{cm} no longer passes through the LISN 91. In other words, the LISN 91 will not detect the current noise of the reverse common-mode noise current i_{cm}.

Please refer to FIG. 6B, which shows a circuit diagram of the switching power converter using the integrated common-mode inductor according to a second embodiment of the present disclosure. Compared to the first embodiment shown in FIG. 6A, the first capacitor C_{X1} shown in FIG. 6B is disposed between an extension section of the first winding N₁ (i.e., a winding section extending from the second side magnetic part 22 to the first side magnetic part 21) and the second terminal of the second winding N₂ and the second terminal of the third winding N₃. For the rest of the same contents, please refer to the corresponding description of FIG. 6A, which will not be described in detail here.

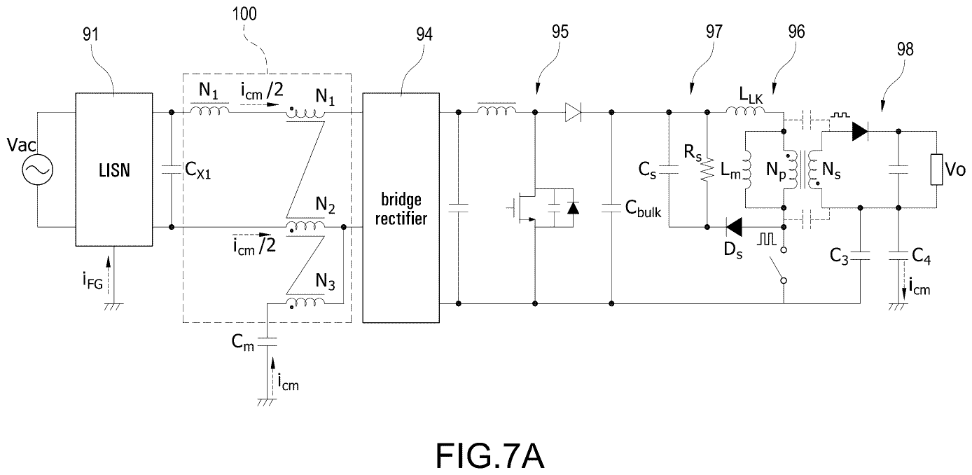

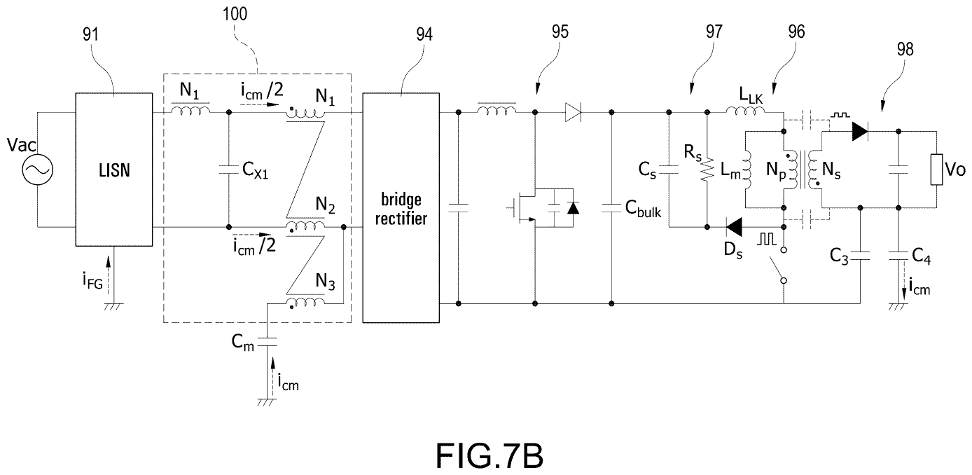

Please refer to FIG. 7A, which shows a circuit diagram of the switching power converter using the integrated common-mode inductor according to a third embodiment of the present disclosure. Compared with the first embodiment shown in FIG. 6A, the connection manner of the second capacitor Cₘ shown in FIG. 7A is different from that of the first embodiment shown in FIG. 6A. Specifically, the first terminal (i.e., the input terminal) of the third winding N₃ is coupled to the first terminal (i.e., the output terminal) of the second winding N₂, and the second terminal (i.e., the output terminal) of the third winding N₃ is coupled to the second capacitor Cₘ. Specifically, the output terminal of the third winding N₃ is coupled to the first terminal of the second capacitor Cₘ, and the second terminal of the second capacitor Cₘ is grounded. For the rest of the same contents, please refer to the corresponding description of FIG. 7A, which will not be described in detail here.

Please refer to FIG. 7B, which shows a circuit diagram of the switching power converter using the integrated common-mode inductor according to a fourth embodiment of the present disclosure. Compared to the third embodiment shown in FIG. 7A, the first capacitor C_{X1} shown in FIG. 7B is disposed between an extension section of the first winding N₁ (i.e., a winding section extending from the second side magnetic part 22 to the first side magnetic part 21) and the second terminal of the second winding N₂ and the second terminal of the third winding N₃. For the rest of the same contents, please refer to the corresponding description of FIG. 7A, which will not be described in detail here.

In summary, the present disclosure has the following features and advantages:
1. Without adding independent magnetic components, the shared core magnetic circuit can be used as an integrated inductor, which conducive to the miniaturization of components.
2. It is to achieve reduction in EMI interference emission intensity of common-mode and differential-mode noise currents.
3. A structure of the common-mode noise cancellation circuit composed entirely of passive components, as evident from experimental results, clearly shows that the same components, when using common-mode noise cancellation techniques, can achieve better common-mode noise cancellation performance.
4. Compared to the traditional passive LC filters under the same number of components, the present disclosure only requires the addition of the third winding. However, since the third winding carries a smaller current, it can be made using finer enameled wire without significantly increasing the size and cost of the coupled inductor.
5. Using a small-size common-mode choke (CM choke) achieves higher filtering performance, and the reduced number of windings and compact size of the CM choke contribute to efficient and compact design.
6. Addition of the third winding using parallel winding method with the existing windings, and the third winding has a smaller wire diameter (lower current), which does not significantly increase the cost.
7. Reliability is higher in designs that are fully composed of passive components.

Although the present disclosure has been described with reference to the preferred embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure as defined in the appended claims.

What is claimed is:

1. An integrated common-mode inductor comprising:
an iron core comprising a center magnetic part, a first side magnetic part, and a second side magnetic part,
a first winding comprising a first terminal and a second terminal, wherein the first winding is wound on the second side magnetic part, and wound on the first side magnetic part to form a structure where the first terminal of the first winding and the second terminal of the first winding are wound out from the first side magnetic part and the second side magnetic part respectively,
a second winding comprising a first terminal and a second terminal, wherein the second winding is wound on the second side magnetic part to form a structure where the first terminal of the second winding and the second terminal of the second winding are wound out from two sides of the second side magnetic part respectively, and
a third winding comprising a first terminal and a second terminal, wherein the third winding is wound on the second side magnetic part to form a structure where the first terminal of the third winding and the second terminal of the third winding are wound out from the two sides of the second side magnetic part respectively,
wherein the first winding wound on the first side magnetic part is configured to provide a differential-mode magnetic flux; wherein the first winding, the second winding, and the third winding wound on the second side magnetic part are configured to provide a common-mode magnetic flux.

2. The integrated common-mode inductor as claimed in claim 1, wherein the first winding is wound on the second side magnetic part, and directly extends to be wound on the first side magnetic part.

3. The integrated common-mode inductor as claimed in claim 1, wherein the first winding is wound on the second side magnetic part, and is wound on the first side magnetic part through a circuit board.

4. The integrated common-mode inductor as claimed in claim 1, wherein the first side magnetic part and the center magnetic part are configured to provide a differential-mode closed magnetic loop through which the differential-mode magnetic flux passes; wherein the second side magnetic part and the center magnetic part are configured to provide a common-mode closed magnetic loop through which the common-mode magnetic flux passes.

5. The integrated common-mode inductor as claimed in claim 4, wherein a direction of the differential-mode closed magnetic loop at the center magnetic part is the same as a direction of the common-mode closed magnetic loop at the center magnetic part.

6. The integrated common-mode inductor as claimed in claim 5, wherein at a time-varying moment, the differential-mode closed magnetic loop is formed by the first side magnetic part and the center magnetic part in a clockwise direction; the common-mode closed magnetic loop is formed by the second side magnetic part and the center magnetic part in a counter clockwise direction.

7. The integrated common-mode inductor as claimed in claim 5, wherein at a time-varying moment, the differential-mode closed magnetic loop is formed by the first side magnetic part and the center magnetic part in a counter clockwise direction; the common-mode closed magnetic loop is formed by the second side magnetic part and the center magnetic part in a clockwise direction.

8. The integrated common-mode inductor as claimed in claim 1, wherein a polarity of the first winding that wound out from one side of the second side magnetic part is the same as a polarity of the second winding and a polarity of the third winding that wound out from the same side of the second side magnetic part.

9. A switching power converter comprising:
a transformer comprising a primary side and a secondary side, and
a primary-side circuit coupled to the primary side, and the primary-side circuit comprising:
a line impedance stabilization network, configured to receive an input power source,
a noise cancellation circuit comprising:
a first capacitor,
an integrated common-mode inductor coupled to the first capacitor, and the integrated common-mode inductor comprising an iron core, a first winding, a second winding, and a third winding, and
a second capacitor coupled to the integrated common-mode inductor, and
a voltage conversion circuit coupled between the integrated common-mode inductor and the primary side.

10. The switching power converter as claimed in claim 9, wherein the first capacitor is coupled between an output side of the line impedance stabilization network and an input side of the integrated common-mode inductor.

11. The switching power converter as claimed in claim 10, wherein the first capacitor is coupled between the second terminal of the first winding and the second terminal of the second winding and the second terminal of the third winding.

12. The switching power converter as claimed in claim 10, wherein the first capacitor is coupled between an extension section of the first winding and the second terminal of the second winding and the second terminal of the third winding.

13. The switching power converter as claimed in claim 9, wherein the second terminal of the second winding is coupled to the second terminal of the third winding, a first terminal of the second capacitor is coupled to the first terminal of the third winding, and a second terminal of the second capacitor is grounded.

14. The switching power converter as claimed in claim 9, wherein the first terminal of the second winding is coupled to the first terminal of the third winding, a first terminal of the second capacitor is coupled to the second terminal of the third winding, and a second terminal of the second capacitor is grounded.

15. The switching power converter as claimed in claim 9, wherein the third winding is configured to generate a reverse current equivalent to a magnitude of a common-mode noise current.

16. The switching power converter as claimed in claim 9, wherein the noise cancellation circuit has a function of a current transformer.

17. The switching power converter as claimed in claim 16, wherein the noise cancellation circuit further has a function of a signal amplifier and/or a function of a signal inverter.

18. The switching power converter as claimed in claim 9, wherein the primary-side circuit further comprises:
a protection circuit, coupled to the primary side of the transformer.
